(19) United States
(12) Patent Application Publication
(10) Pub. No.: US 2008/0137532 A1
(43) Pub. Date: Jun. 12, 2008

(54) Fault tolerance in wireless networks operating in ad-hoc mode

(75) Inventors: Srivastava Namburi, Keshawpur (IN); Ramakrishna Boyina, Bangalore (IN); Jagadeesh Brahmajosyula, Guntur (IN); Amit S. Punpale, Bangalore (IN); Vinayak S. Kore, Bangalore (IN); Arun V. Mahasenan, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/637,904

(22) Filed: Dec. 12, 2006

(51) Int. Cl. H04L 12/26

(52) U.S. Cl. 370/225

(57) ABSTRACT

A wireless network system includes a plurality of nodes. Each node includes two or more redundant network interfaces, and each one of these network interfaces operates on a different channel. A plurality of links couple the nodes together. A layer residing on each of the nodes detects a link status associated with each interface, and switches to a redundant interface of a node when the link degrades beyond a tolerance. The routing and control layer provides redundant non-overlapping routes.

### TECHNICAL FIELD

Various embodiments relate to networks, and in an embodiment, but not by way of limitation, to fault tolerance in wireless networks.

### BACKGROUND

For wireless networks to be considered as a viable alternative to wired networks, the wireless networks must satisfy performance criteria such as reliability, availability, integrity, long range/coverage, and timeliness. It is challenging to achieve these criteria in wireless networks, especially those installed in harsh environments.

Wireless networks can be configured to enable peer to peer communication between neighboring nodes of the network. Such a configuration is commonly referred to as an ad-hoc wireless network. These networks can be configured to form multi-hop mesh networks. Multi-hop networks typically offer longer effective communication ranges or coverage than conventionally configured single hop wireless networks. However, other issues such as robustness and dependability still remain. Additionally, in mesh networks, a considerable amount of traffic related to the network and routing mechanisms consumes the available bandwidth of the network.

### BRIEF DESCRIPTION OF THE DRAWINGS

FIG. 1 illustrates an example embodiment of wireless network nodes in an Ad-hoc mode.

FIG. 2 is a table listing possible failure modes in a wireless network.

FIG. 3 is a table listing several architectural options for addressing the failure modes of FIG. 2.

FIG. 4 illustrates an example embodiment of a wireless network in which the nodes of the network include dual network interfaces.

FIG. 5 illustrates an example embodiment of a wireless network in which the nodes of the network include three network interfaces.

FIG. 6 illustrates an example embodiment of an enhanced device architecture for a network.

### OVERVIEW

In an embodiment, a wireless network includes a plurality of nodes. Each node in the network includes two or more redundant network interfaces, and each of these network interfaces operates in a different communication channel. The nodes are coupled together with a plurality of wireless links. A middleware layer residing on each of the nodes detects the link status associated with each interface, and switches to a redundant interface of a node when the link degrades beyond a tolerance.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

Wireless mesh networks offer a wide variety of advantages such as extended network operating range or coverage, ease of installation, configuration, and maintenance, and are cheaper in cost compared to an infrastructure mode of operation. Nevertheless, mesh networks have their own set of problems like additional communication delays due to multi-hop transmissions, routing overheads in terms of route discovery and route information maintenance, and performance of the network (depends on network size). Apart from these, wireless mesh networks have to live with the traditional issues associated with wireless technologies such as link reliability, robustness, etc. Thus, in one or more embodiments, an architecture makes the communication in the wireless mesh networks more resilient to failures and also addresses the issue of overhead due to the routing information exchanged between the nodes. The embodiments disclosed herein provide fault tolerance through redundancy. In at least one embodiment, a middleware layer based architecture provides and manages this redundancy-based fault tolerance.

In an embodiment, one or more architectures increase dependability by providing mechanisms for fault tolerance in the wireless networks. While in this disclosure these architectures are presented in connection with the IEEE 802.11x wireless standard, the architectures are not so limited, and the embodiments disclosed herein can be applied to any wireless network, and in particular ad-hoc wireless networks that support multiple non-overlapping channels or multiple accesses in the same channel like Code Division Multiple Access (CDMA) or Time Division Multiple Access (TDMA). The architectural embodiments disclosed herein make these entire wireless networks more robust and dependable by selecting the best available link/route between the nodes making communication more robust and dependable.

One or more embodiments address the fact that performance of multi-hop mesh networks is prone to degradation due to failure of wireless links between nodes and failure of intermediate nodes. The architectures disclosed herein incorporate a fault tolerance mechanism into the devices so that they can handle these problems and provide robust communication between the wireless nodes.

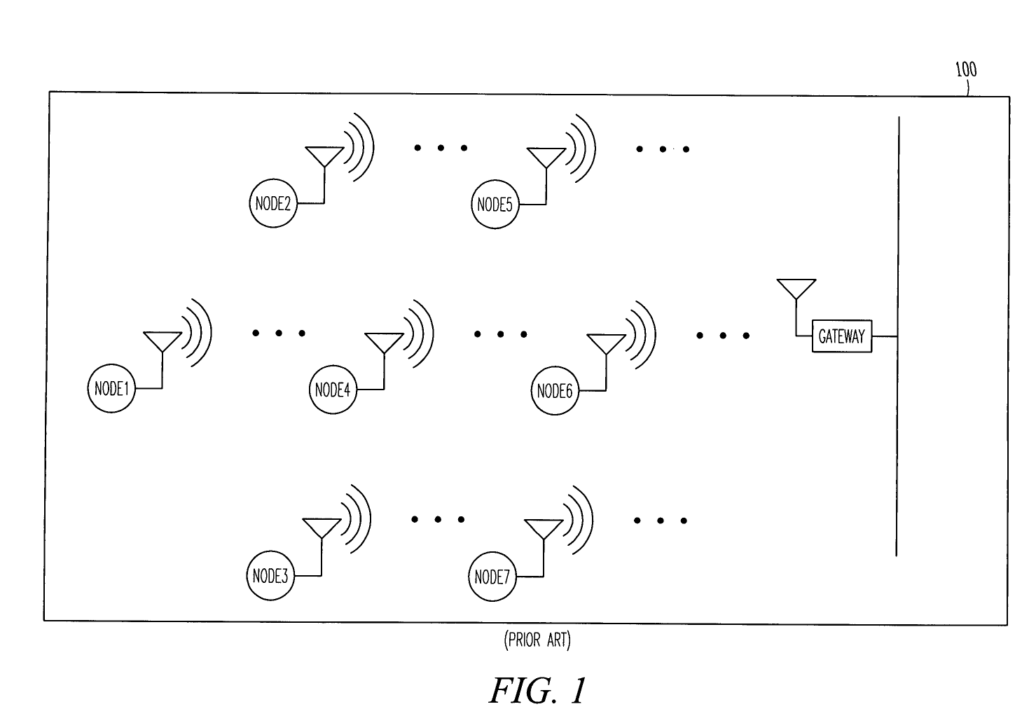

Normally, wireless networks are operated in “Infrastructure Mode”, also referred to as the master-slave mode. In this mode of operation, a central master controls the network resources and the communication traffic between the nodes. Any communication between the nodes in this mode is coordinated by a network master/coordinator. Alternatively, one can configure these nodes in Ad-hoc mode, wherein the nodes can communicate with their peer nodes directly. However, a disadvantage of the Ad-hoc mode is the network operating range or coverage that can be achieved using the ad-hoc mode is limited to the range of its transceiver. This problem can be overcome by incorporating routing capabilities into the wireless nodes and forming a wireless mesh network. With this capability, the wireless nodes can communicate with distant nodes with the help of the intermediate nodes that fall in their route. Such wireless networks are referred to as multi-hop wireless mesh networks. A typical wireless mesh network 100 is as shown in FIG. 1. In mesh networks, each node can act as a router and can perform activities such as route discovery and route maintenance for itself as well as for other nodes. Any routing protocols known in the art can be used for this purpose.

With reference again to FIG. 1, if node 1 desires to communicate with the Gateway, it first attempts to determine the path to its destination using any routing protocol that is known in the art. Thus any packet of information from Node1 to the gateway hops through any, all, or some of the intermediate nodes (Nodes 2 through 7) depending upon the route selected by the routing protocol in use.

The basic topology of the wireless mesh network of FIG. 1 is applicable to embodiments throughout this disclosure. In FIG. 1, each node (i.e., Node1-Node7) is assumed to have more than one immediate neighbor node. Additionally, more than one non-overlapping route exists between a source and a destination in the network of FIG. 1. The routing protocol will determine all the possible non-overlapping routes between the source and the destination node and will provide the node with the two optimal routes. For example, with reference to FIG. 1, two possible non-overlapping routes between Node 1 and the Gateway would be:

Route 1:—Node1→Node2→Node5→Gateway

Route 2:—Node1→Node3→Node7→Gateway

It is well known that the wireless communication link is susceptible to failures due to interference, channel fading, reflecting obstructions, etc. Apart from these physical factors, there are several other factors such as congestion in the network, failure of the interface cards and devices that increase chances of communication failure. One of the possible solutions to achieve reliability is to modify the communication protocol layers like Medium Access Control and Link Layer Control along with robust modulation techniques. The other approach is to combat the effects of an unreliable communication medium by incorporating fault tolerance into the system. This invention focuses on the second approach and explains various mechanisms in which fault tolerance can be provided. The mechanisms are based on link or channel redundancy between the wireless nodes, route redundancy between the source and destination, path redundancy for a given route, redundancy of network interface, and nodes.

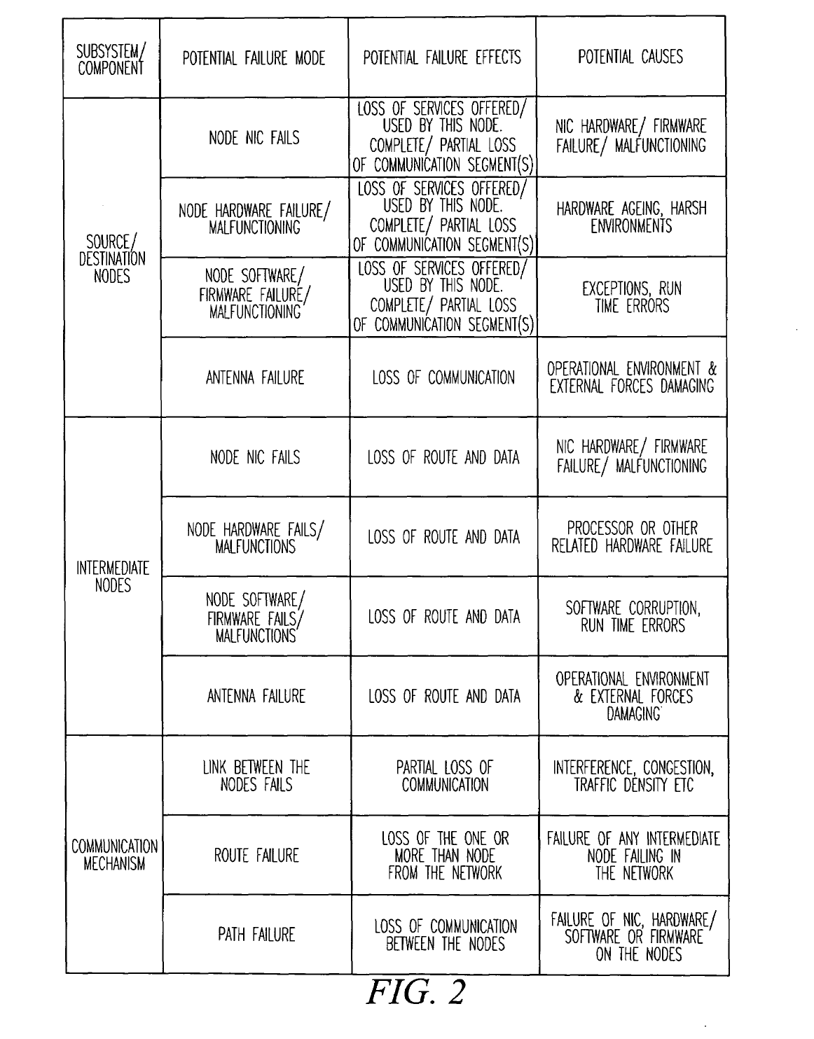

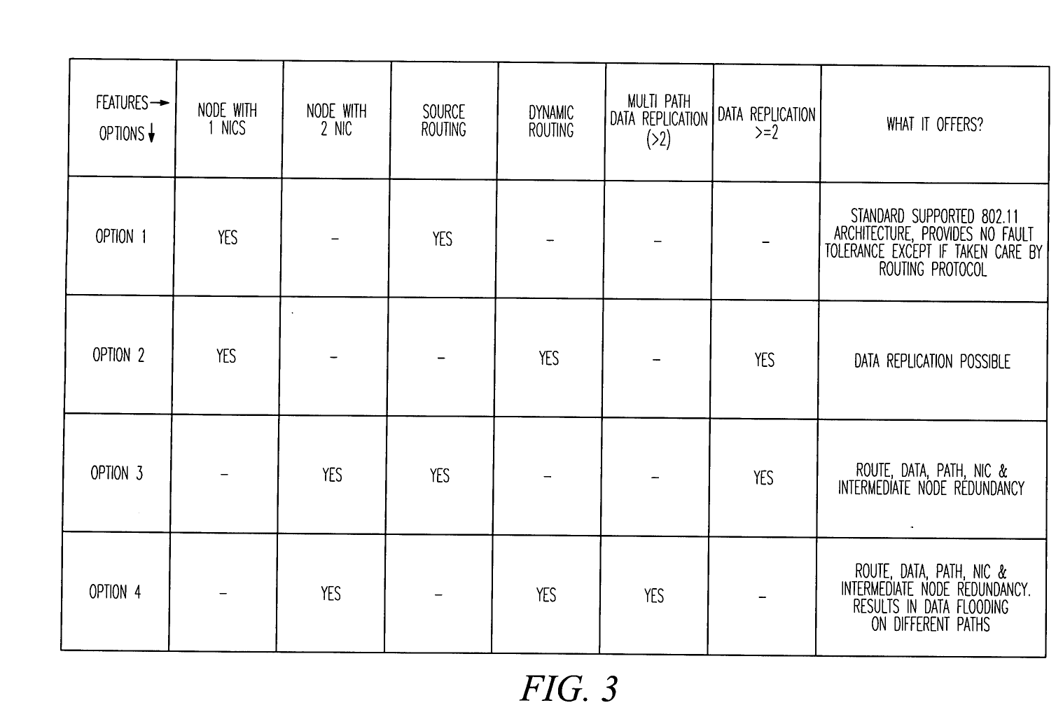

These fault tolerance mechanisms also provide features such as application level transparency, zero delay in switchover and also backward compatibility so that the fault tolerant nodes would be able to communicate with the similar non-fault tolerant nodes having same MAC and PHY layers. FIG. 2 illustrates possible modes in which faults can arise in a wireless network operating in mesh-mode represented by FIG. 1. FIG. 2 lists the potential sub-system failures, their possible causes and the impact of these failures on the communication between sub-systems. FIG. 3 illustrates examples of various architectural options that can be used to overcome the failure modes highlighted in FIG. 2.

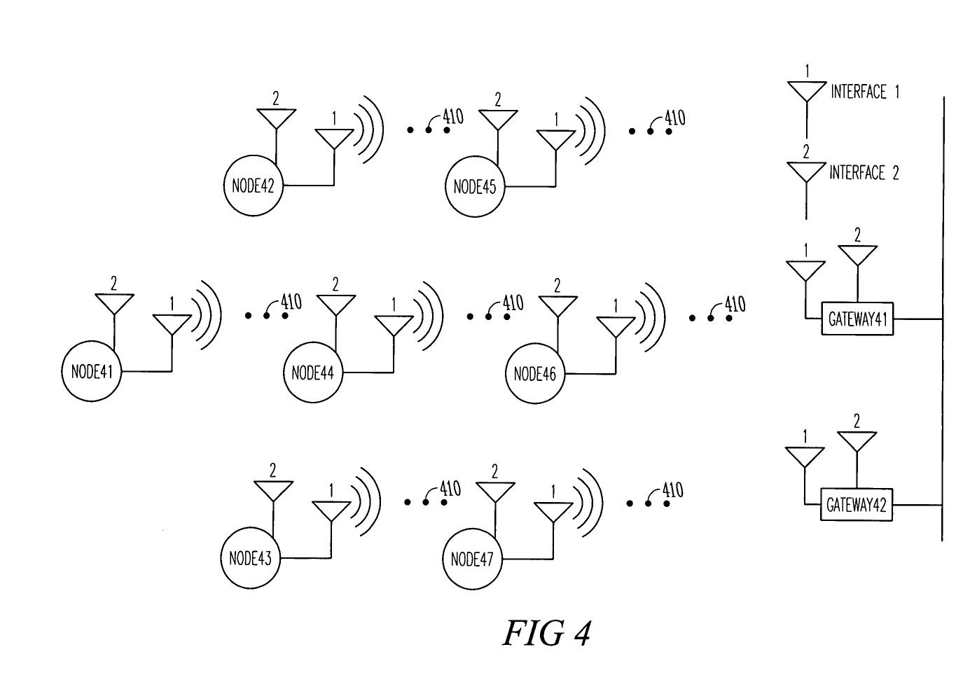

FIG. 4 illustrates an embodiment wherein each node has two network interfaces, each operating on different channels, preferably non-overlapping with respect to each other. As shown in FIG. 4, each node has two network interfaces, interface 1 and interface 2. With these two network interfaces, the number of communication paths via links 410 between a source node and a destination node, for a given route, depends on the total number of intermediate nodes through which the packet passes. In other words, the total number of hops needed for a packet transmitted by a source node to reach the desired destination node determines the available paths for communication between those two nodes.

The middleware layer of each node detects link status associated with each interface by monitoring the link health on each of the interfaces and initiates the process of switching over to the redundant interface in the event of the failure of one interface or degradation of corresponding link beyond tolerance. The tolerance can be set to a level determined by the developer and/or operator of the network based on reliability requirement and error tolerance of the application. Depending on the availability of routes, routing protocol attempts to provide two optimal non-overlapping routes between the source and the destination.

In addition, the middleware layer provides dual paths between each pair of nodes by configuring the network interface cards in non-overlapping channels.

For example, in the network shown in FIG. 4, non-overlapping channels made available through redundant network interfaces can be used to provide redundancy as follows. If Node41 intends to communicate with Node42, which happens to be its immediate neighbor (the destination being just one hop away from the source and the route being Node41→Node42), the available paths for communication would be:

Path1 - Node41 1 → Node42 1
Path2:- Node41 2 → Node42 2

If Node41 desires to communicate with Node45 via Node42 (which means
the destination node for Node41 is on the second hop and the route being Node41 →
Node42 → Node45), the available paths for communication would be:

Path1:- Node41 1 → Node42 1 → Node45 1
Path2:- Node41 1 → Node42 1 → Node42 2 → Node45 2
Path3:- Node41 2 → Node42 2 → Node45 2
Path4:- Node41 2 → Node42 2 → Node42 1 → Node45 1

If Node41 (Source) desires to communicate with Gateway41 (GW41) as its
destination via Node42 and Node45 (in the sense, the route from Node41 to
Gateway41 is Node41 → Node42 → Node45 → GW41), the available paths between
the source and destination in this case would be:

Path1:- Node41 1 → Node42 1 → Node45 1 → GW41 1
Path2:- Node41 1 → Node42 1 → Node45 1 → Node45 2 → GW41 2
Path3:- Node41 1 → Node42 1 → Node42 2 → Node45 2 → GW41 2
Path4:- Node41 1 → Node42 1 → Node42 2 → Node45 2 → Node45 1

→ GW41 1

Path5:- Node41 2 → Node42 2 → Node45 2 → GW41 2
Path6:- Node41 2 → Node42 2 → Node45 2 → Node45 1 → GW41 1
Path7:- Node41 2 → Node42 2 → Node42 1 → Node45 1 → GW41 2
Path8:- Node41 2 → Node42 2 → Node42 1 → Node45 1 → Node45 2

→ GW41 2

From the above examples, it can be seen that the number of redundant paths available between a source wireless node and a destination wireless node depends upon the number of hops. If the destination is ‘n’ hops away from the source, the number of redundant paths available is 2ⁿ when each node is provided with two network interface cards.

In this approach, despite providing redundant network interfaces on each node, the failure of any of the intermediate nodes will result in the failure of communication between the source and the destination nodes. Failure of both paths/links between any two nodes on a route also results in loss of communication between the source and destination. Hence, to provide tolerance to node failures and dual path/link failures, a route redundancy is implemented by exploiting the available non-overlapping routes. In this scenario, the source node can either multicast the data on the same channel to its neighbors, or it can unicast data to its neighbors on non-overlapping routes over different channels. Subsequently, the intermediate nodes can unicast/multicast the data either on one of the two interfaces based on their channel assessment, or they can unicast/multicast the data on both their channels. The latter approach would result in multiple instances of the same packets being received at the destination node and less effective throughput. A user can choose between the options of the intermediate nodes multicasting on different routes (possible if distributed routing protocol is used) and channels or just unicast (if only source routing protocols are used) on one of the preferred routes and channel based on the inputs from the middleware layer based on reliability requirement in given environment and BW requirement of the application. However, the source node would multicast the data packets on more than one route. Thus, this approach ensures both data, route, and node redundancy to augment the channel redundancy already provided by dual network interfaces provided in each node.

Thus in this approach, the number of paths available for a packet from a source node to reach the destination node in a ‘n’ hop network would be in multiples of 2ⁿ, where the multiplying factor depends upon the number of alternate non-overlapping routes used to convey the packet, and the manner in which the intermediate nodes would forward this packet (multicast or unicast). Additionally, data redundancy and node redundancy are also assured in this approach.

Another embodiment with reference to FIG. 4 relates to the use of one of the network interfaces (e.g., interface 1) on the nodes for exchanging the network related control and routing information, which in mesh networks constitutes a considerable amount of traffic, and the other network interface (e.g., interface 2) for data communication amongst the nodes. Though this approach isolates the control traffic from the data traffic and increases the performance of the overall network, the advantage of having redundant communication paths as explained earlier would be compromised. However, if this idea is coupled with features of data redundancy and node redundancy by transmitting packets of both data and control information over more than one non-overlapping route, redundant paths can still be provided for the communication of both data and control information.

IEEE's 802.11x networks provide three non-overlapping frequency channels. In such a case, the number of available paths would be in multiples of 3ⁿ. Therefore, in general, in a multi-hop mesh network, with each node having ‘m’ interfaces, the number of redundant paths available (for a single route) between a source and destination is mⁿ.

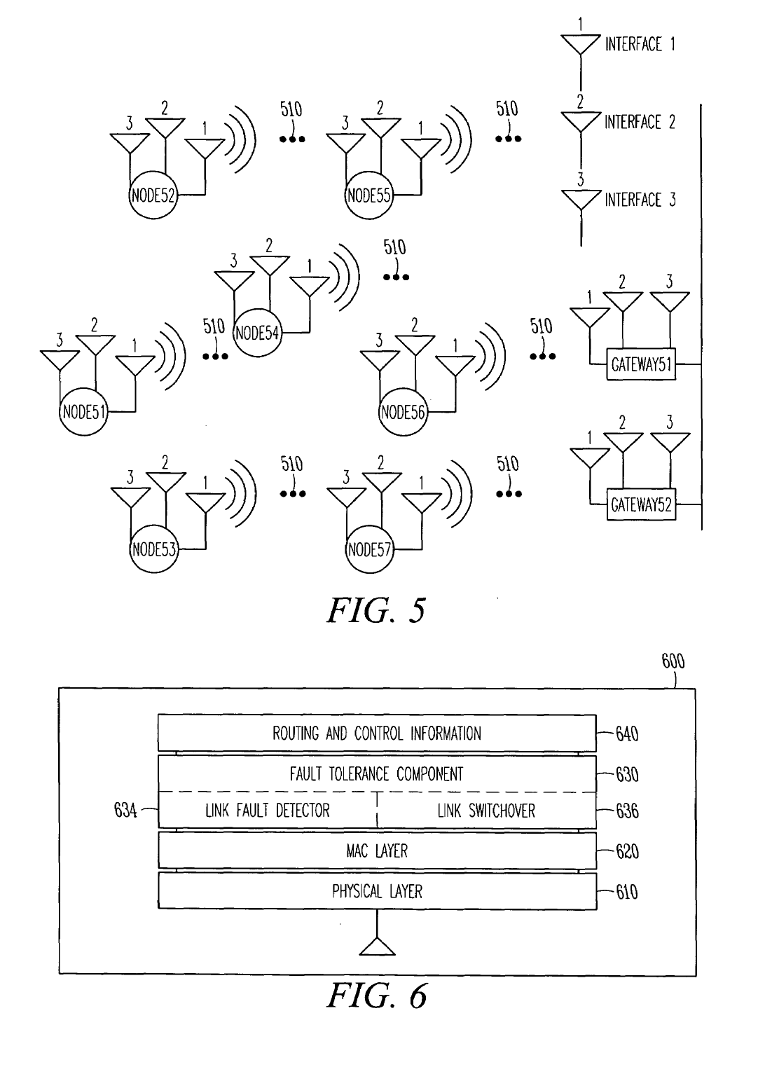

FIG. 5 illustrates an embodiment wherein each wireless node includes three interfaces. FIG. 5 further illustrates a plurality of links 510 among the nodes. In a particular embodiment, each of these three interfaces operates on three different non-overlapping channels. Out of the three available interfaces, two interfaces can be used for data communication and one interface can be used for exchanging the control information and routing information. Thus it would be possible to isolate the data traffic from the control traffic, and fault tolerance would be achieved as two interfaces are being used for data communication. On the other hand, all three channels can be used for redundant communication, wherein once again the number of available redundant paths between a source node and a destination node would depend on the distance in terms of number of hops between them. Thus, as previously referred to, an ‘n’ hop network would have 3ⁿ different paths between them. Once again, in this mode of operation, the nodes can maintain and exchange this control information along with the routing information either for each network interface or it can be done even on a per node basis. In addition to channel redundancy node, data and route redundancy can also be provided with this approach.

Apart from these, redundancy can be provided at the gateway level as is illustrated in FIG. 4. In the event of the failure of a gateway (e.g., gateway41), the redundant gateway (e.g., gateway42) can take over its functionalities. On the other hand, data redundancy as proposed earlier can be enhanced if nodes can deliver packets to both the gateways.

In order to achieve the desired fault tolerant properties explained above, the architecture of the fault tolerant nodes can be slightly modified as shown in FIG. 6. In the architecture 600 of FIG. 6, there is a physical layer 610, a MAC layer 620, and a Fault Tolerant or middleware layer 630 that includes two blocks—a link fault detector 634 (LFD) and a link switchover 636 (LSO). A routing and control information layer 640 sits on top of the fault tolerant layer 630.

The LFD 634 primarily detects the non-availability of the given communication link. The LFD 634 can perform this task based on combinations of several options including a sudden drop in the Receive Signal Strength Indication(RSSI), an observation regarding the amount of congestion in a given link, the number of packets waiting for the medium in the transmission queue, the total number of re-transmissions/successful transmissions, and any other techniques known in the art.

Based on these observations, once the LFD 634 determines that the given link is unusable, the LSO 636 switches over to the redundant link based on the architecture alternatives suggested earlier. In short, the fault tolerant layer 630 depicted in FIG. 6 can perform the following functionalities. First, the middleware layer can control the initial association, routing, and control information exchange processes. It has to make sure that the two NIC cards can associate with the appropriate interfaces of the neighboring nodes over two non-overlapping channels so that maximum fault tolerance can be achieved. Second, it has the fault detection mechanism to detect the fault in the link. Third, if the fault occurs in the preferred link, the application traffic can be shifted to the back up link transparent to the application.

It is to be understood that the above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

In the above detailed description of embodiments of the disclosure, various features are grouped together in one or more embodiments for streamlining the disclosure. This is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments, with each claim standing on its own as a separate embodiment. It is understood that the above description is intended to be illustrative, and not restrictive. It is intended to cover all alternatives, modifications and equivalents as may be included within the scope of the disclosure as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A wireless network system comprising:
a plurality of nodes, each node including two or more redundant network interfaces, each of the network interfaces operating on a different channel;
a plurality of links, the links coupling together two or more of the nodes; and
a layer resident on each of the nodes;
wherein the layer resident on each of the nodes detects a link status associated with each interface; and further
wherein the layer resident on each of the nodes switches to a redundant interface of a node when the link degrades beyond a tolerance.

2. The wireless network system of claim 1, further comprising a routing protocol, the routing protocol providing each node with at least two non-overlapping routes between a source node and a destination node.

3. The wireless network system of claim 2, wherein each of said non-overlapping routes comprise one or more paths linking said nodes of said network.

4. The wireless network system of claim 1, wherein the channels of the nodes are non-overlapping.

5. The wireless network system of claim 1, further comprising a gateway interface, the gateway interface comprising two or more redundant interfaces.

6. The wireless network system of claim 1, wherein one or more nodes transmit data through the two or more redundant network interfaces.

7. The wireless network of claim 1, wherein one or more nodes transmit data through only one of its redundant interfaces.

8. The wireless network of claim 1, wherein one of the redundant network interfaces is for the transmission of network control and routing information, and another of the redundant network interfaces is for the transmission of data.

9. The wireless network of claim 1, wherein each node includes two redundant network interfaces.

10. The wireless network of claim 1, wherein each node includes three redundant network interfaces.

11. The wireless network of claim 1, wherein the layer resident on each of the nodes comprises a middleware layer.

12. The wireless network of claim 11, wherein the middleware layer comprises a link fault detector and a link switchover.

13. A wireless network system comprising:
a plurality of nodes, each node including three redundant network interfaces; each of the network interfaces operating on a different channel;
a plurality of links, the links coupling together two or more of the nodes; and
a layer resident of each node;
wherein the layer is for detecting a link status associated with each interface;
wherein the layer is for switching to a redundant interface of a node when the link degrades beyond a tolerance; and further
wherein two of the redundant network interfaces are for the transmission of data, and one of the redundant network interfaces is for the exchange of control information and routing information.

14. The wireless network system of claim 13, further comprising a routing protocol, the routing protocol providing each node with at least two non-overlapping routes between a source node and a destination node.

15. The wireless network system of claim 13, wherein each of the three interfaces operate on three different non-overlapping channels, and further wherein each of the three channels are for the transmission of control information, routing information, and the transmission of data.

16. The wireless network system of claim 13, further comprising a gateway interface, the gateway interface comprising three redundant interfaces.

17. The wireless network of claim 13, wherein
the network comprises a mesh network; and further
wherein the layer resident of each node comprises a middleware layer.

18. A wireless network node comprising:
a physical layer;
a medium access control (MAC) layer on top of the physical layer;
a fault tolerant component on top of the MAC layer; and
a routing and control information layer on top of the fault tolerant layer.

19. The wireless network of claim 18, wherein the fault tolerant layer comprises a link fault detector and a link switchover.

20. The wireless network of claim 19, wherein the link fault detector is configured to detect the non-availability of a communication link analyzing one or more of a drop in the signal to noise ratio of a link, congestion in the link, a number of packets in a transmission queue, and a number of successful transmissions and re-transmissions.
